(19) United States
(12) Patent Application Publication
(10) Pub. No.: US 2017/0140387 A1
(43) Pub. Date: May 18, 2017

(54) METHOD AND APPARATUS TO PROVIDE PROACTIVE CUSTOMER CARE

(71) Applicant: AT&T Intellectual Property I, L.P., Atlanta, GA (US)

(72) Inventors: Prabir Nandi, Duluth, GA (US); Sanjeev Devarapalli, Dunwoody, GA (US); Karthik Rajagopalan, Allen, TX (US)

(21) Appl. No.: 14/941,989

(22) Filed: Nov. 16, 2015

(51) Int. Cl. G06Q 30/00; G06N 5/02

(52) U.S. Cl. CPC G06Q 30/016; G06N 5/022

(57) ABSTRACT

A method, non-transitory computer-readable storage device, and apparatus for providing a proactive customer care service. For example, the method collects data from a plurality of communication channels related to a plurality of touchpoints, determines a plurality of journeys from the plurality of touchpoints, where at least one of the plurality of journeys is classified as a negative journey, determines a start of the negative journey by a user, and interacts with an endpoint device of the user before a next touchpoint for the negative journey is reached by the user.

The present disclosure relates generally to a method and apparatus to provide proactive customer care, e.g., proactively anticipating and addressing a user's concern or issue before the user becomes discontent with the service provided by a service provider and the like.

### BACKGROUND

A user may interact with a service provider via a number of different communication channels, e.g., calling the service provider using a telephone, interacting with a website of the service provider, interacting with an Interactive Voice Response (IVR) system of the service provider, and the like. The service provider is often unable to predict the intent of the interaction and the communication channel that will be selected by a user until the user has already reached out to the service provider. Thus, a service provider's response as to a customer care issue is often reactive instead of proactive.

### SUMMARY OF THE DISCLOSURE

In one embodiment, the present disclosure describes a method, non-transitory computer-readable storage device, and apparatus for providing a proactive customer care service. For example, the method collects data from a plurality of communication channels related to a plurality of touchpoints, determines a plurality of journeys from the plurality of touchpoints, where at least one of the plurality of journeys is classified as a negative journey, determines a start of the negative journey by a user, and interacts with an endpoint device of the user before a next touchpoint for the negative journey is reached by the user.

### BRIEF DESCRIPTION OF THE DRAWINGS

The teaching of the present disclosure can be readily understood by considering the following detailed description in conjunction with the accompanying drawings, in which:

FIG. 1 illustrates an illustrative network related to the present disclosure;

FIG. 2 illustrates an example method of the present disclosure for providing proactive customer care; and

FIG. 3 depicts a high-level block diagram of a computer suitable for use in performing the functions described herein.

To facilitate understanding, identical reference numerals have been used, where possible, to designate identical elements that are common to the figures.

### DETAILED DESCRIPTION

The present disclosure broadly describes a method, non-transitory computer-readable storage device, and apparatus for providing proactive customer care. Customer care services are often designed to address various concerns, issues or problems that a user may encounter. For example, a user visiting a provider's website may then follow up with a phone call to a customer care center of the provider (e.g., a product provider or a service provider) to further inquire about particular features of a product or service offered by the provider. Similarly, a customer who has subscribed to a service from a service provider may encounter a problem with the subscribed service and will then call a customer care center of the service provider to discuss the encountered problem. In yet another example, a customer may have an issue with a purchased product from a product provider such as a brick and mortar retailer or an online retailer, and will then call a customer care center of the product provider to discuss the encountered problem. Thus, a provider may deploy any number of customer care communication channels in anticipation that users and customers will likely reach out to the provider for various issues or problems. Providers will incur a substantial cost in deploying and maintaining such customer care communication channels, which are often considered a necessary component of doing business.

As discussed above, a user may interact with a provider, e.g., a service provider, via a number of different communication channels, e.g., calling the service provider using a telephone, interacting with a website of the service provider, interacting with an Interactive Voice Response (IVR) system of the service provider, and the like. Unfortunately, the service provider is often unable to predict the intent of the interaction and the communication channel that will be selected by a user until the user has already reached out to the service provider. For example, a user may initiate a telephone call (e.g., a type of communication channel) to the service provider complaining that the user is experiencing a substantial amount of dropped calls from the cellular phone service (e.g., a type of intent of the interaction) or there are excessive charges on the user's bill (e.g., another type of intent of the interaction). Thus, a service provider's response as to a customer care issue is often reactive instead of proactive. In other words, the intent of the user interaction with the service provider is not anticipated until the user conveys the intent during the telephone call. Similarly, the modality of the communication that will be used by the user is not anticipated until the user selects a particular modality of communication to reach the service provider.

Broadly, an automated communication channel encompasses any communication modality (e.g., using a mobile application, using a website to perform a transaction, using an Interactive Voice Response (IVR) system, using a messaging service (e.g., an email or a text message) and the like) that does not require a real time interaction with a live person, individual or agent, e.g., a live customer care agent. In contrast, a non-automated communication channel encompasses a real time interaction with a live agent which may include speaking with a live person via a phone call or an online chat.

With the proliferation of many sophisticated automated communication channels, many service providers have reduced the number of customer care agents who are employed at customer care centers. Such reductions are necessary to allow the service provider to gain efficiency, e.g., to reduce the overall cost of providing various services to the customers. However, such cost savings may impact the level of customer care services that the service provider is able to provide to its customers. For example, with a reduced staff of live customer case agents, a service provider may rely on the customers interacting with the many sophisticated automated communication channels to implement transactions and/or to report and resolve possible technical issues specific to the customers. However, some customers may be unwilling to engage these automated communication channels due to personal preferences, lack of technical ability to use these automated communication channels, and/or lack of confidence that such automated communication channels will produce the desired results. Irrespective of the reasons, it is beneficial to promote the adoption of automated communication channels by a customer since such automated communication channels are often available 24 hours a day and are often able to address a customer's issue immediately. Furthermore, the cost associated with the deployment and maintenance of these automated communication channels by the service provider is considerably less than the deployment of live agents in one or more customer care centers. The live agents are often limited in terms of number and the time in which such live agents are available to assist customers. Thus, a customer may be dissatisfied with having to wait a long period of time on the phone to speak with a live agent or is frustrated with having to speak with a live agent only during business hours when such live agents are actively on duty.

It is often the case that the automated communication channels are readily available and are able to address the customer's issues or perform a transaction required by the customer. For example, if the service provider is a network service provider that is providing communication services (e.g., local and/or long distance telephony services, cellular services, email messaging services, text messaging services and the like), data services (e.g., file transferring services, Internet access services and the like), and/or multimedia services (e.g., multimedia content delivery services such as delivering movies, videos, songs, and the like), and/or security services (e.g., home or business security monitoring service), then the customer may have to perform a transaction and/or have an inquiry pertaining to one of the provided services. Such transactions and/or inquiries can often be resolved through automated communication channels without the need to interact with a live agent.

To illustrate, a customer may be traveling out of the country and is attempting to subscribe to an international traveling plan with respect to having a cellular service, a data service and a text messaging service while traveling outside of the country. Such subscription can be handled by a live agent who is contacted by the customer to setup the international traveling plan for a time period selected by the customer. The customer may call a toll free number of the network service provider to speak with a live agent who will setup the international traveling plan for the customer. However, the network service provider may already have a website where such international traveling plan can be automatically subscribed to by any customers without the need to interact with any live agents. In fact, it is often the case that the customer is able to subscribe to such services online faster and with less wasted time than speaking with a live agent.

In another example, a customer may be having a technical issue with a service, e.g., the access speed to the Internet may be an issue. Under this example, a customer may call the network service provider to inquire and/or to complain that the access to the Internet is problematic. In turn, the live agent may have the customer execute a series of tests that will diagnose the potential speed issue raised by the customer. Again, the network service provider may already have a website where such series of tests can be readily accessed by any customers without the need to interact with any live agents. In fact, it is often the case that the customer is able to run these tests online faster and with less wasted time than speaking with a live agent.

In yet another example, a customer may have an issue with a billing issue, e.g., an itemized charge on the bill. Under this example, a customer may call the network service provider to inquire and/or to complain that the itemized charge on the bill may be an error. In turn, the live agent may have the customer specify which itemized charge on the bill is the issue and then provide an explanation as to why the itemized charge on the bill is incurred. Again, the network service provider may already have a website where a comprehensive billing system that can be readily accessed by any customers without the need to interact with any live agents. The billing system may clearly show each itemized charge with a detailed explanation of the incurred charge and allow a customer to investigate each charge online. In other words, supporting documentations can be readily made available online for the customer. Thus, it is often the case that the customer is able to access the billing system online faster and with less wasted time than speaking with a live agent.

However, the unwillingness of a customer to adopt such automated communication channels increases the cost of the network service provider and results in dissatisfaction with the customer having to wait a long period of time before a live agent is made available. Thus, it is beneficial that the customer is encouraged to adopt the use of automated communication channels. However, it is noted that by the time the customer is reaching out to the network service provider via a non-automated communication channels, it would be too late to persuade the customer to use one of the other automated communication channels. In other words, once the customer decides to call the network service provider, it is already too late to persuade the customer to use one of the other automated communication channels. Thus, the type of communication modality used by a user can impact a user's satisfaction with the customer care service of a provider.

In addition to communication modality, the “journey” taken by a user may also impact a user's satisfaction with the customer care service of a provider. To illustrate, a “journey” comprises a series of “touchpoints” between the customer and the service provider. For example, a touchpoint is broadly an interaction between the customer and the service provider. For example, various types of touchpoints may exist, e.g., a marketing touchpoint, an acquisition touchpoint or a use touchpoint. A marketing touchpoint comprises an interaction (e.g., via an automated communication or a non-automated communication channel) pertaining to a marketing event. For example, a marketing touchpoint may comprise a customer visiting a service provider's website to view a marketing offer, a customer calling a service provider to inquire about a new service, a service provider sending an email to the customer offering a new service, a service provider calling the customer to offer a new service, a service provider sending a text message, e.g., an Short Message Service (SMS) message (broadly sending a message directed to the endpoint device of the user), to the customer with a new offer, and the like.

In another example, an acquisition touchpoint comprises an interaction (e.g., via an automated communication or a non-automated communication channel) pertaining to the acquisition of a service. For example, an acquisition touchpoint may comprise a customer visiting a service provider's website to order a service, a customer calling a service provider to order a new service, a service provider sending an email to the customer indicating a date and time when a technician will arrive at the customer's premises to install the new service, a service provider calling the customer to request a time to install the new service, a service provider sending a text message, e.g., an SMS message, to the customer that the new service is now operating, and the like.

In another example, a use touchpoint comprises an interaction (e.g., via an automated communication or a non-automated communication channel) pertaining to the use of a service. For example, a use touchpoint may comprise a customer visiting a service provider's website to view usage parameters relating to a service (e.g., minutes used, cost incurred, and the like), a customer calling a service provider to inquire about the speed of a service, a service provider sending an email to the customer indicating a failure relating to the service that will impact the customer, a service provider calling the customer to fix a piece of equipment relating to an existing service subscribed by the customer, a service provider sending a text message, e.g., an SMS message, to the customer that a current bill for an existing service is overdue, and the like.

In turn, a “journey” traversed by a customer may involve any number of the above described touchpoints. For example, an illustrative journey may involve: 1) the service provider sending an email offer to the customer, 2) responsive to the email offer, the customer visits a website of the service provider, 3) the customer then calls a live agent of the service provider to ask various service related questions, 4) the customer then subscribes to the service using an IVR system of the service provider, 5) the service provider sends a text message to the customer indicating that the service is now provisioned and activated, and 6) the customer reviews a bill online for the newly installed service. In another example, an illustrative journey may involve: 1) the service provider sending an email notice to the customer of an increase in the cost of an existing service, 2) responsive to the increase, the customer visits a website of the service provider, 3) the customer then calls a live agent of the service provider to ask various cost related questions, and 4) the customer then terminates the service using an IVR system of the service provider. In yet another example, an illustrative journey may involve: 1) the service provider sending an email notice to the customer of an opportunity to upgrade an existing service, 2) responsive to the opportunity, the customer visits a website of the service provider, 3) the customer then calls a live agent of the service provider to ask various related questions for the opportunity, 4) the customer then accepts the opportunity for upgrading the existing service on a website of the service provider, 5) the service provider sends a new piece of equipment to the customer via a mail service, 6) the customer activates the newly received equipment and connects to a network of the service provider, 7) the service provider's network detects the newly deployed equipment at the customer's premises and configure the newly deployed equipment remotely, and 8) the service provider sends a text message that the upgraded service has been provisioned and is now activated.

It should be noted that the above described journeys and touchpoints are only illustrative and should not be interpreted as limitations to the present disclosure. It should be noted that each journey may comprise any number of non-automated communication interactions and any number of automated communication interactions between the customer and the service provider. In fact, the “goal” or “intent” of a journey can be achieved via different paths with different starting points or “triggers.” Said another way, the “end” or “destination” of a journey can be arrived through different touchpoints. For example, if the goal of a journey is to activate a new service for a customer, then one path may involve a first customer calling the service provider (e.g., a type of start or trigger) to activate the new service, whereas another customer may visit a website (e.g., another type of start or trigger) of the same service provider to activate the new service. Thus, both journeys of these two illustrative customers arrived at the same destination, but the journeys taken by these two customers are different.

Thus, journeys may encompass any number of goals and intents. For example, journeys may comprise: a billing journey (e.g., a journey that ends in a billing function being performed, e.g., sending a billing, removing a charge, providing an explanation for a billed charge, and the like), an order journey (e.g., a journey that ends in an ordering function being performed, e.g., ordering a service, ordering new equipment to be sent to the customer, upgrading an existing service, adding a feature to an existing service and the like), a service journey (e.g., a journey that ends in a service being performed, e.g., performing a diagnostic test (e.g., a test for reporting low video quality, broadband quality issues, and the like), sending a signal to a customer device (e.g., Residential Gateway (RG) Reachability tests can be used to determine connectivity to the customer premises or customer equipment), sending a technician to perform an onsite test, and the like).

As discussed above, a user may traverse various different types of journeys. However, some journeys can be classified as “positive” journeys or “negative” journeys by the service provider. For example, a journey that results in a resolution of a problem or concern of a user can be classified as a positive journey. In another example, a journey that results in an adoption of a new service or a new feature of a service by a user can be classified as a positive journey. In yet another example, a journey that results in the use of a preferred communication channel, e.g., an automated communication modality by a user can be classified as a positive journey. In other words, “positive” journeys may encompass interactions between the user and the service provider that produce results relating to one or more of: an increase in the satisfaction of the user, an increase in the revenue of the service provider, a reduction in the operating cost of the service provider, and the like.

In contrast, a journey that does not result in a resolution of a problem or concern of a user can be classified as a negative journey. In another example, a journey that results in a termination of an existing service or an existing feature of a service by a user can be classified as a negative journey. In yet another example, a journey that results in the user having to contact the service provider, e.g., in a first instance or repeated instances can be classified as a negative journey, since there is a cost to the service provider for each contact with the user. In yet another example, a journey that results in the use of a non-preferred communication channel, e.g., a non-automated communication modality by a user can be classified as a negative journey. In other words, “negative” journeys may encompass interactions between the user and the service provider that produce results relating to one or more of: a decrease in the satisfaction of the user, a decrease in the revenue of the service provider, an increase in the operating cost of the service provider, and the like.

One aspect of the present disclosure is to channel a user who is on a “negative” journey to a “positive” journey or to simply terminate the traversal of the negative journey by the user. To illustrate, the service provider may have a large body of historical data that will indicate the series of touchpoints that may lead to a destination of a negative journey. Consider a “porting out” of a service example, where a first journey may comprise: 1) a user visiting a website of a service provider to review the subscription term for a service contract, 2) the user calling the service provider to speak to a live agent to inquire about any outstanding charges, and 3) the user calling back the service provider at a future time to terminate the service. A second journey with the same destination (e.g., “porting out” of a service), may comprise: 1) a user calling a service provider to complain about a deficiency of the service experienced by the user, 2) the user calling the service provider again three days later to complain about the same deficiency of the service experienced by the user, and 3) the user terminating the service via the website. Both journeys end at the same destination, i.e., both users end up porting out of the service, e.g., switching cellular service to a different cellular service provider while retaining the same cellular phone number.

Thus, the cost to the service provider can be very substantial if a user is allowed to complete the “negative” journey. At minimum, a user who completes a negative journey may be dissatisfied, and at worst, the user may no longer be a customer of the service provider. Thus, one aspect of the present disclosure is to provide a proactive customer care service to terminate a negative journey or to channel the negative journey to a positive journey.

Another aspect of the present disclosure is to gather data from a plurality of touchpoint channels, e.g., telephone call records (e.g., call detail records (CDRs), website access data, email messages, text messages, previous customer care agent interactions, and the like. These historical data can be collected and applied to a learning method for deducing one or more journeys. For example, data for each user can be analyzed across all communication channels for that particular user, e.g., based on the calling phone number of the user, social security number of the user or any other user identifier associated with the user. The analysis will attempt to match the user's various interactions to determine whether the various interactions will fit within one or more particular types of journey destinations. For example, destinations of a journey may comprise: 1) adoption of a new service, 2) adoption of an upgrade to an existing service, 3) termination of an existing service, 4) downgrade of an existing service, 5) request for a replacement equipment, 6) request for a technician to arrive at a customer premises, 7) request to speak to a customer care agent, 8) request to speak to a supervisor customer care agent, 9) posting of a negative comment on a website of the service provider, and so on. As the historical data is processed, one or more paths of various journeys will be uncovered by the automated or machine learning processes. Different paths leading to the same destination of a journey will be identified and analyzed. In one embodiment, these paths are compared to identify positive journeys versus negative journeys. In other words, in one implementation, the present method is able to determine whether the user is currently on a positive journey or a negative journey, or alternatively, whether the user is likely to transition over to a positive journey from a negative journey or vice versa. Furthermore, the present method is able to determine touchpoints that involve non-automated communication channels versus automated communication channels. In one embodiment, a user on a negative journey will be encouraged to stop the negative journey and/or be transitioned to a positive journey.

Using the “porting out” example above, (e.g., 1: a user visits a website of a service provider to review the subscription term for a service contract, 2: the user calls the service provider to speak to a live agent to inquire about any outstanding charges, and 3: the user calls back the service provider at a future time to terminate the service), the present method may attempt to terminate the user's negative journey or divert the user to a positive journey as soon as possible. For example, the present method may detect that a user is using the website of the service provider (e.g., a first touchpoint) to review the subscription term for a service contract towards the end of a billing cycle, e.g., near the end of a monthly billing cycle, near the end of a yearly contract, and so on. If such user review based on the automated learning processes indicates that there is a high propensity that the user is contemplating the action of porting out, then the present method will attempt to proactively interact with the user, e.g., calling the user (broadly directing a telephone call to the endpoint device of the user) by a live agent to inquire on the satisfaction of the user with the prescribed service, sending a text messaging to the user providing an added feature without any additional charge for a predefined period of time, sending the user an email with a link to provide feedback in exchange for a monetary credit and so on. In other words, the method is attempting to terminate the user's traversal of the negative journey or to divert he user to a positive journey.

Continuing on the example, if the user persists on the negative journey and reaches the second touchpoint of calling the service provider to speak to a live agent to inquire about any outstanding charges, then the present method will provide a real time indication to the live agent who is speaking with the user to notify the live agent that the user on the call is currently on a negative journey of porting out. This real time notification to the live agent will allow the live agent to proactively engage the user to reduce the possibility of the user reaching the future third touchpoint where the user will call the service provider to terminate the service and have the user phone number ported to another service provider. For example, the live agent may have a plurality of predetermined interactions or remedial actions to address the user being on the current negative journey, e.g., the live agent can be authorized to offer a discount for the current service, to offer a new feature for the current service, to offer an extension for the current service for a discount if the user is willing to renew the service for an extended period of time (e.g., renewing the service for another year), to speak to a supervisor customer care agent to address any issues related to the current service, to offer the user help with the current service (e.g., sending the user to speak with a technical support personnel), to offer the user with a diagnostic test for the current service (e.g., sending the user to a website where a diagnostic test can be triggered remotely to test the user's current service, scheduling a visit by a technician to the user's home of business so that the user can verify any perceived issues with the technician), and so on. Previously, without such real time notification of the present disclosure that the user is currently on a negative journey, the live agent may provide the requested information to the user and the call will be terminated and classified as having resolved the user's inquiry for information, which is true, but does not properly ascertain as to the true intent of the user making such inquiry. The present method allows for the intent of the user to be predicted so that remedial actions can be taken proactively.

In one example, the present method computes one or more propensity scores to determine whether the user is currently on a negative journey or will transition to a negative journey. For example, the present method may compute one or more of: a propensity score for likely to contact, a propensity score for likely to repeat contact, a propensity score for likely to fail, and a propensity score for likely to adopt.

For example, a propensity score for likely to contact may encompass a propensity for a user to contact the service provider via a non-preferred communication modality, e.g., calling a customer care number to speak with a live agent of the service provider. In another example, a propensity score for likely to repeat contact may encompass a propensity for a user to contact the service provider repeatedly via a non-preferred communication modality, e.g., calling repeatedly a customer care number to speak with a live agent of the service provider. In another example, a propensity score for likely to fail may encompass a propensity for a user to be unsatisfied with a remedial action, e.g., a user is not satisfied with a verbal explanation with an incurred charger, a user is not satisfied with a verbal explanation of a service failure or a service degradation, a user is not satisfied with a service appointment, e.g., a recent installation of equipment at the user's site, a user is not satisfied with the performance of a purchased or leased equipment, a user is not satisfied with a customer agent's verbal response in general, and the like. In another example, a propensity score for likely to adopt may encompass a propensity for a user to adopt a recommendation provided by the service provider, e.g., adopting a preferred communication modality (e.g., using the service provider's website to access billing information, or using the service provider's IVR system), adopting a new service, adopting a new service feature, and the like.

Each of the above mentioned propensity scores can be generated by taking onto account a number of user parameters such as 1) the services currently subscribed by the user, 2) the length of time that the user has subscribed to each of the subscribed services, 3) the specific demographic information of the user (e.g., age, gender, geographic location of the user's residence, education level, type of employment, and the like), 4) the perceived mental state of the user (e.g., analyzing words used on the call, or measuring the tone and volume of the phone call to detect anger or stress associated with the user (e.g., raising of voice, presence or absence of laughter, use of inappropriate language, and so on), 5) the current state of the interaction (e.g., the length of the current interaction (e.g., the length of a phone call, the number of exchanged text messages, the current state of a workflow for a remedial action), the current communication modality of the interaction (e.g., a phone call, text messaging interaction, online chat interaction, or email messaging interaction)). The particular set of parameters to be used for computing each propensity score can be learned using machine learning algorithms.

In one example, the propensity score for likely to repeat contact may comprise a number of factors such as: 1) Tenure+2) Total Due Amount+3) Product Type+4) Video Quality Index (VQI)+5) Broadband Quality Index (BQI)+6) Prior Calls in 30 days+7) AGE+8) Household-Size+9) Education-Level+10) Home Owner/Renter+11) Marital_Status. The factor “Tenure” may comprise a length of time that the caller has subscribed to a service. The factor “Total Due Amount” may comprise a total amount due for a subscribed service, e.g., the total amount due for a monthly service. The factor “Product Type” may comprise the type of product (broadly a service) that the user has subscribed to, e.g., a cellular service, a data service, a telephony service, a multimedia delivery service, and so on. The factor “Video Quality Index” may comprise a measure of a video quality for a subscribed service pertaining to the delivery of video content to the user. The factor “Broadband Quality Index” may comprise a measure of a broadband access quality, e.g., for Internet connect, for a subscribed service. The factor “Prior Calls in 30 days” may comprise a measure of a number of calls made by the user to the customer care center within the last 30 days. The factor “Age” may comprise an age of the user. The factor “Household-Size” may comprise a number of individuals in the household of the user. The factor “Education-Level” may comprise an education level of the user, e.g., high school level education, college level education, post graduate level education and the like. The factor “Home Owner/Renter” may comprise a home ownership status of the user, e.g., whether the user owns a home or whether the user is a renter. The factor “Marital_Status” may comprise a marital status of the user, e.g., whether the user is married or single. In other words, in one example the propensity score for likely to repeat contact is calculated using this set of illustrative factors.

In another example, the propensity score for likely to adopt (e.g., likely to adopt an automated communication channel) may comprise a number of factors such as: 1) Repeat Calls in 3 days+2) Contacts via non-automated channel in 30 days+3) Contacts via automated channel in 30 days+4) Fallouts from website to calls in 3 days+5) Education Level+6) Household Income+7) Age+8) Billing Inquires+9) Payment Inquiries. The factor “Repeat Calls in 3 days” may comprise a measure of whether the user has previously repeated a call to the customer care center within 3 days after an earlier phone call. The factor “Contacts via non-automated channel in 30 days” may comprise a measure of a number of contact made by the user via non-automated communication channels within the last 30 days. The factor “Contacts via automated channel in 30 days” may comprise a measure of a number of contact made by the user via automated communication channels within the last 30 days. The factor “Fallouts from website to calls in 3 days” may comprise a measure of whether the user has called the customer care center after using the website of the service provider. The factor “Education-Level” may comprise an education level of the user, e.g., high school level education, college level education, post graduate level education and the like. The factor “Household-Income” may comprise a measure of the total income of the user's household. The factor “Age” may comprise an age of the user. The factor “Billing Inquires” may comprise a measure as to whether the user has previously made a billing inquiry or whether the user is currently making a billing inquiry. The factor “Payment Inquiries” may comprise a measure as to whether the user has previously made a payment inquiry or whether the user is currently making a payment inquiry. In other words, in one example the propensity score for likely to adopt is calculated using this set of illustrative factors.

In another example, the propensity score for likely to fail (e.g., likely to not adopt an automated communication channel) may comprise a number of factors such as: 1) Age+2) Education Level+3) Product Type+4) Automation Failures (website unable to query status of order/apt, etc.)+5) Recent Order+6) Upcoming Dispatch+7) Video Quality Index (VQI)+8) Broadband Quality Index (BQI)+9) Prior Calls in 30 days. The factor “Age” may comprise an age of the user. The factor “Education-Level” may comprise an education level of the user, e.g., high school level education, college level education, post graduate level education and the like. The factor “Product Type” may comprise the type of product (broadly a service) that the user has subscribed to, e.g., a cellular service, a data service, a telephony service, a multimedia delivery service, and so on. The factor “Automation Failures” may comprise whether the user has previously experienced a failure of using an automated communication channel, e.g., a website to query status of an order and the like. The factor “Recent Order” may comprise a status as to whether the user has placed a recent order, e.g., an order of a new service. The factor “Upcoming Dispatch” may comprise a status as to whether the user is expecting an upcoming dispatch of service personnel to the user's home or business, e.g., a service call for installing a new service or fixing an existing service. The factor “Video Quality Index” may comprise a measure of a video quality for a subscribed service pertaining to the delivery of video content to the user. The factor “Broadband Quality Index” may comprise a measure of a broadband access quality, e.g., for Internet connect, for a subscribed service. The factor “Prior Calls in 30 days” may comprise a measure of a number of calls made by the user to the customer care center within the last 30 days. In other words, in one example the propensity score for likely to fail is calculated using this set of illustrative factors.

For example, the machine learning algorithm may comprise a Gradient Boosted Decision Tree (GBDT) algorithm. However, any other algorithms for machine learning, e.g., a neural network algorithm, may be used.

Prior to being used to perform a prediction, the learning algorithm needs to be trained. For example, historical data associated with each type of destination of a journey can be gathered for a plurality of users, e.g., interaction data for each user that ended in the user porting out can be gathered and classified as porting out historical data. Similarly, interaction data for each user that ended in the user requesting a live agent supervisor can be gathered and classified as requesting for live agent supervisor historical data. Similarly, interaction data for each user that ended in the user adopting a preferred communication modality can be gathered and classified as adopting a preferred communication modality historical data. Similarly, interaction data for each user that ended in the user subscribing to a new service can be gathered and classified as subscribing to a new service historical data. Thus, a large volume of user interactions can be classified and sorted into different sets of historical data sets that can be used as training sets for machine learning algorithms. In one example, each set of historical data can be divided such that one half of the historical data is used to train the machine learning algorithm and the remaining half of the historical data is used to test the machine learning algorithms to determine whether the machine learning algorithms are making the correct predictions.

In turn, once the machine learning algorithms are trained and tested, the machine learning algorithms are deployed to monitor the interactions of each user, e.g., monitoring for each user the interaction of the user with the service providers across a plurality of communication channels or modalities. In turn, the monitoring includes computing one or more of the above mentioned propensity scores to anticipate the likely behavior of each user to provide a proactive customer care service.

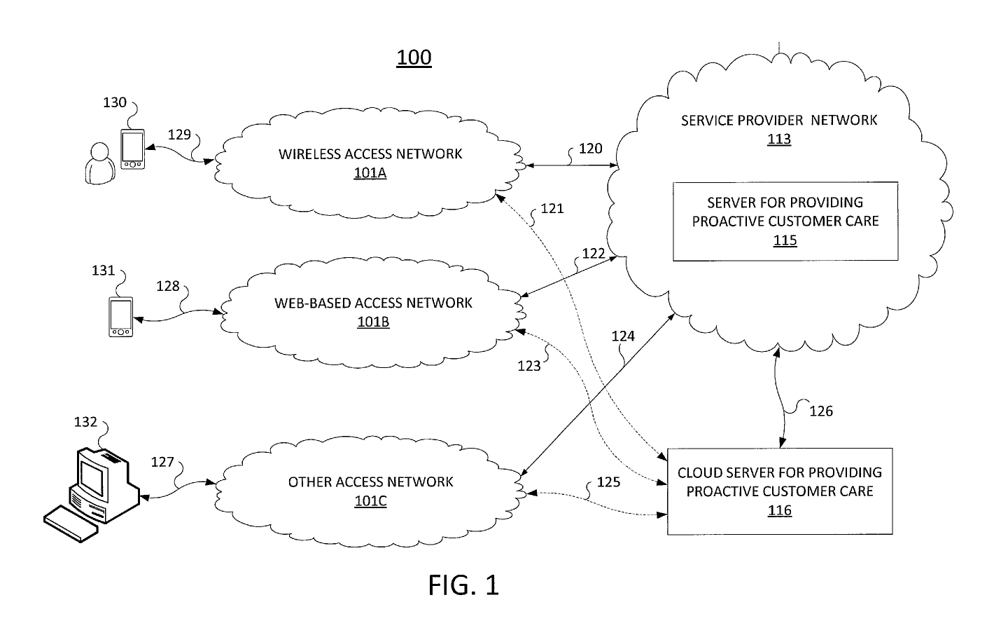

FIG. 1 illustrates an exemplary network 100 related to the present disclosure. In one illustrative embodiment, the network 100 comprises a wireless access network 101a (e.g., a cellular access network, a wireless fidelity (Wi-Fi) access network and the like), a web-based access network 101b (e.g., an Internet-based access network), other access network 101c (e.g., a telephony access network, a Voice over Internet Protocol (VoIP) access network, and the like), and a core service provider network 113 (or broadly a core network). The wireless access network 101a may comprise any number of wireless access networks, e.g., Wi-Fi networks, 2G networks, 3G networks, LTE networks, satellite network, etc. The core network 113 may comprise any number of application servers, gateway devices, routers, switches, databases, firewalls etc. of a network service provider (not shown). For example, the core network 113 may comprise an application server 115 for providing a proactive customer care service to a user, e.g., a dedicated database server can be deployed to monitor users' interaction with a service provider for providing the proactive customer care service to the user. The core network 113 may also be communicatively coupled to one or more cloud servers 116. The method of the present disclosure may be implemented in a server of a service provider network, e.g., server 115, or a cloud server, e.g., server 116, of the present disclosure. The access networks 101a-101c communicate with application servers 115 and/or 116 via various types of communication channels 120-126.

Although the teachings of the present disclosure are discussed below in the context of a core network, the teaching is not so limited. Namely, the teachings of the present disclosure can be applied in any types of wireless networks (e.g., 2G network, 3G network, a long term evolution (LTE) network, and the like) or any types of wire based networks (e.g., public switched telephone network, Internet Protocol (IP) networks, cable networks, etc.), wherein promoting the adoption of a digital communication channel by a user, is beneficial.

FIG. 1 also illustrates various user endpoint devices 130-132. The user endpoint devices 130-131 access services via the wireless access network 101a or the web-based access network 101b via various types of communication channels 128-129. The user endpoint device 132 accesses services via the other access network 101c (e.g., a fiber optic network, a cable network, etc.) via various types of communication channels 127. It should be noted that the network 100 is only illustrative and the number of network components or elements are not specifically limited as shown. Any number of network elements and components can be deployed. For example, there may be several wireless networks, several wire based access networks, several different core networks, several cloud servers, and the like. In addition, any number of network elements may be deployed in each of the networks.

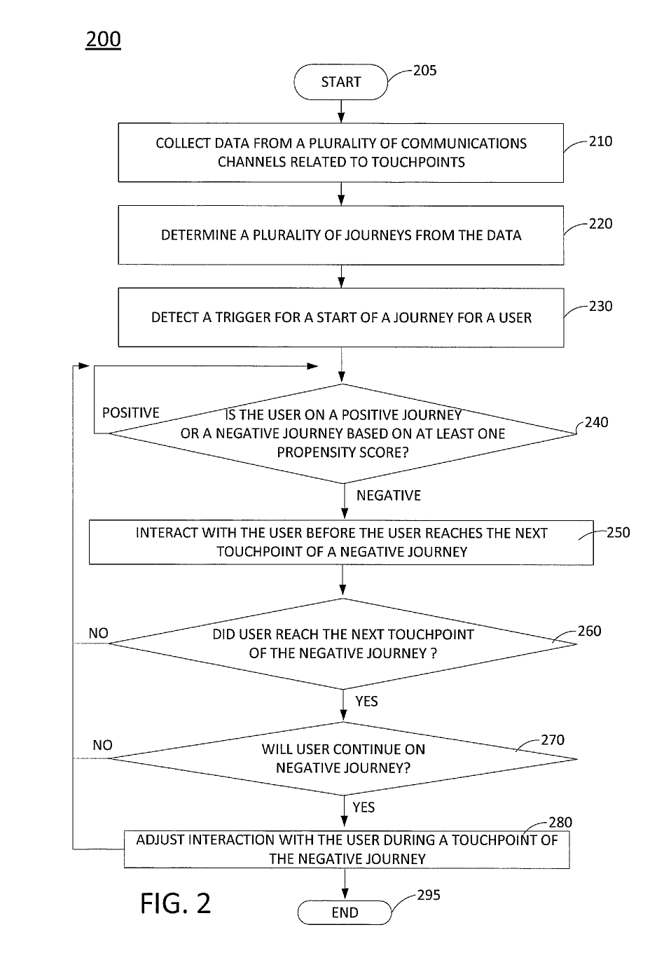

FIG. 2 illustrates a flowchart of a method 200 of the present disclosure for providing a proactive customer care service to a user. For example, the method may be implemented in a dedicated server, e.g., an application server of a network service provider, a cloud server, etc. Method 200 starts in step 205 and proceeds to step 210.

In step 210, method 200 collects data from a plurality of communication channels related to touchpoints. For example, method 200 collects historical data from a plurality of different communication channels (e.g., digital communication channels and non-digital communication channels) for a plurality of different touchpoints.

In step 220, method 200 determines at least one journey (e.g., one or more journeys) from the collected data. For example, the method 200 may employ a machine learning algorithm or a neural network to learn a plurality of possible journeys. In fact, different paths leading to the same journey destinations are noted as are the number of touchpoints of each possible path including the number of touchpoints comprising automated communication channels versus the number of touchpoints comprising non-automated communication channels.

In step 230, method 200 detects a trigger for a start of a journey for a user. For example, each of the determined journey in step 220 comprises a trigger or the beginning of the journey, e.g., a user calling the service provider, the user visiting a website of the service provider, the service provider sending a promotional offer to the user, the service provider sending a text message to the user, the user suffered a failure in a subscribed service and so on. These “triggers” can be monitored so that the present method will be able to detect the start of a journey taken by each user.

In step 240, method 200 determines whether the user is on a positive journey or a negative journey as discussed above. If the user is on a positive journey, the method 200 simply returns to step 240 to continue the monitoring without taking any actions. In other words, if the user is on a positive journey, there is no need to provide any proactive customer care service to the user at this point. If the user completes the entire positive journey to its destination, then no action is taken by method 200. If the user is on a negative journey, the method 200 proceeds to step 250.

In step 250, the method 200 interacts with the user before the user is able to reach the next touchpoint of the negative journey. For example, the method 200 may proactively take a remedial action, e.g., calling the user via a live agent, sending the user a text message, sending the user an email message, sending the user a promotional offer (e.g., a discount for a subscribed service, an offer a new feature for a subscribed feature without charge (e.g., offering a conference call feature to a cellular service subscriber) and so on). Said another way, the service provider will compute one or more propensity scores as disclosed above to determine whether the user is currently on a negative journey. If the user is on a negative journey, the service provider will proactively initiate contact with the user before the next predicted touchpoint of the negative journey can be reached.

In step 260, method 200 determines whether the user has reached the next touchpoint of the negative journey. If the user has not reached the next touchpoint in the negative journey, method 200 returns to step 240 to continue monitoring of the user's current journey. In other words, the user has been successfully diverted to a positive journey or the user has been persuaded to terminate the current negative journey. If the user has reached the next touchpoint in the negative journey, method 200 proceeds to step 270.

In step 270, method 200 determines whether the user will continue on the negative journey. For example, the user may have reached the next touchpoint where the user has called a customer care center to speak with a live agent. During the interaction with the user at this touchpoint, the method 200 in step 270 is attempting to determine whether the user will continue on the negative journey, e.g., the method 200 may monitor the tone and voice volume of the user on the call, the method 200 may monitor the content of the call or an online chat session to determine whether the user's concern or problem is being addressed to the user's satisfaction. For example, one or more steps of a workflow of a remedial action can be monitored to determine whether the user is being persuaded to terminate the negative journey. For example, a workflow of a remedial action may comprise: 1) asking the user to explain a service failure, 2) conducting an automated test to determine whether the user's subscribed service is currently experiencing a service failure or a service degradation, 3) providing the test result to the user, 4) compensating the user with a credit if a service failure or a service degradation is detected that impacted the user, 5) bring about a service restoration action to address the service failure or the service degradation, 6) querying the user to determine if the user's problem has been solved, and 7) ending the interaction with the user when the user indicated that the reported problem has been satisfactorily addressed. If the user and the live agent are proceeding according to the workflow in a timely manner, then method 200 will deem that the user will likely not continue on the negative journey. However, if the user and the live agent are not proceeding according to the workflow in a timely manner (e.g., taking a long period of time to conduct the automated test, or the user is unwilling to follow the steps of the work flow), then method 200 will deem that the user will likely continue on the negative journey.

Returning to step 270, if method 200 determines that the user is likely not to continue on the negative journey, method 200 returns to step 240 to continue monitoring of the user's current journey. In other words, the user has been successfully diverted to a positive journey or the user has been persuaded to terminate the current negative journey. If method 200 determines that the user is likely to continue on the negative journey, method 200 proceeds to step 280. For example, the one or more computed propensity scores calculated during the current touchpoint may indicate that the interaction will likely end in failure (e.g., the user is raising his voice and using inappropriate language during the interaction with the live agent). In other words, it is clear that the live agent is not addressing the user's concern in a way that will end in the user being satisfied with the interaction with the live agent.

In another example, the one or more computed propensity scores calculated during the current touchpoint may indicate that the interaction will likely end with the user calling back again in the near future (e.g., the user has recently subscribed to a multimedia delivery service and is asking how to program a remote controller for the multimedia delivery service). It may be that historical data shows that a user who calls the service provider with questions pertaining to programming a remote controller has a very high likelihood that the user will call again for another programming issue within 3 days.

In step 280, method 200 adjusts the interaction with the user during the touchpoint of a negative journey. For example, if the user is raising his voice and using inappropriate language, the present method will suggest to the live agent to exit the work flow of a remedial action and to divert the call to a supervisor live agent. In other words, the method will automatically signal to the live agent, e.g., providing a visible indication on the live agent's display to forward the call to a supervisor live agent for further handling. Alternatively, the method will automatically signal to the live agent, e.g., providing a visible indication on the live agent's display to forward a text message or an email message having an embedded link (e.g., a URL link) that will provide the user with a tutorial as to how to program a remote controller. In other words, the method 200 is providing an adjustment to the interaction with the user during the current touchpoint to ensure that the user will not leave this touchpoint and then proceed to the next touchpoint of the negative journey. Such real time adjustment in the interaction with the user will increase the likelihood of diverting the user from the negative journey. Thus, the present method is able to proactively interact with the user before the user reaches a touchpoint and/or the present method is able to proactively adjust the interaction with the user during a touchpoint of a negative journey.

After step 280, method 200 returns to step 240 to continue monitoring of the user's journey or method 200 may end in step 295. It should be noted that method 200 may operate continually. Namely, the descriptions of method 200 having a start step 205 and an end step 295 are not to be interpreted as limitations of the present disclosure.

It should be noted that the method 200 is described in view of a single user. However, the method is not so limited. The method can be implemented in parallel for a plurality of users.

It should be noted that although not explicitly specified, one or more steps, functions, or operations of the method 200 described above may include a storing, displaying and/or outputting step as required for a particular application. In other words, any data, records, fields, and/or intermediate results discussed in the methods can be stored, displayed, and/or outputted to another device as required for a particular application. Furthermore, steps, functions, or operations in FIG. 2 that recite a determining operation, or involve a decision, do not necessarily require that both branches of the determining operation be practiced. In other words, one of the branches of the determining operation can be deemed as an optional step.

As such, the present disclosure provides at least one advancement in the technical field of automated customer service by providing a proactive customer care service. This advancement is in addition to the traditional interaction of users with the service provider. In other words, the present disclosure provides a dedicated application server 115 or 116 that is configured to perform the specific functions as discussed in FIG. 2 and is tasked with providing a proactive customer care service to a user who is deemed to be on a negative journey. Such adoption of a proactive customer care service will reduce the overall cost of the network service provider and enhances the overall satisfaction of the customer.

The present disclosure also provides a transformation of customer interaction data. For example, historical customer interaction data is transformed into notification data that can be used to determine whether an interaction with a user should be preemptedly initiated to encourage the user to abandon a negative journey.

Finally, embodiments of the present disclosure improve the functioning of a computing device, e.g., a dedicated customer care application server. Namely, a dedicated customer care application server is improved by utilizing historical customer interaction data to anticipate the need of the user and to provide the user with an interaction initiated by the service provider.

Furthermore, the service provider is able to quickly determine first touchpoint resolution (FTR) or first contact resolution (FCR) statistics, which are statistics relating to whether users' problems are satisfactorily addressed on a first contact. Traditionally, (FTR) or (FCR) statistics are determined using customer surveys which are difficult to obtain and are generally delayed in time, i.e., the customer's feedbacks may take some time to be received, aggregated and then analyzed. In contrast, the continuous monitoring of the users' journeys allow the present disclosure to quickly deduce (FTR) or (FCR) statistics and to react accordingly with the appropriate remedial actions.

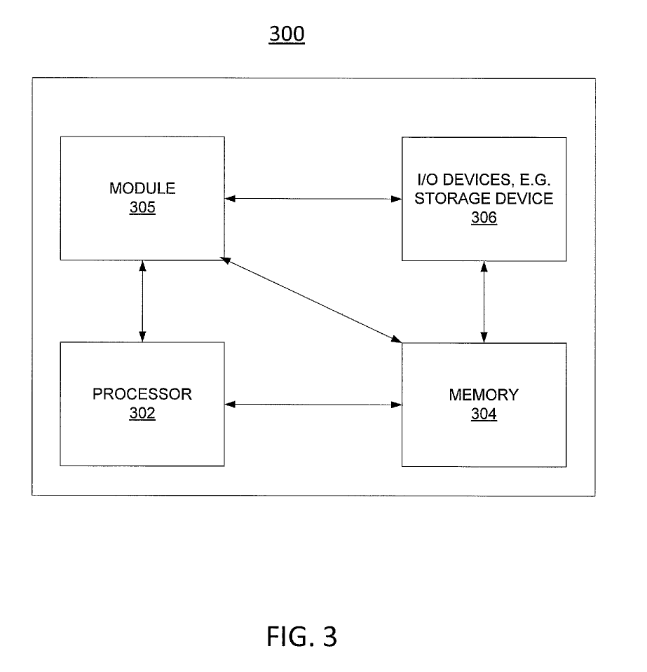

FIG. 3 depicts a high-level block diagram of a computer, e.g., a dedicated application server, suitable for use in performing the functions described herein. As depicted in FIG. 3, the system 300 comprises one or more hardware processor elements 302 (e.g., a central processing unit (CPU), a microprocessor, or a multi-core processor), a memory 304, e.g., random access memory (RAM) and/or read only memory (ROM), a module 305 for providing a proactive customer care service to a user, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computer may employ a plurality of processor elements. Furthermore, although only one computer is shown in the figure, if the method 200 as discussed above is implemented in a distributed or parallel manner for a particular illustrative example, i.e., the steps of the above method 200, or the entire method 200 is implemented across multiple or parallel computers, then the computer of this figure is intended to represent each of those multiple computers.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computer or any other hardware equivalents, e.g., computer readable instructions pertaining to the method(s) discussed above can be used to configure a hardware processor to perform the steps, functions and/or operations of the above disclosed method. In one embodiment, instructions and data for the present module or process 305 for promoting the adoption of a digital communication channel for a journey by a user (e.g., a software program comprising computer-executable instructions) can be loaded into memory 304 and executed by hardware processor element 302 to implement the steps, functions or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 305 for providing a proactive customer care service to a user (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not a limitation. Thus, the breadth and scope of a preferred embodiment should not be limited by any of the above-described exemplary embodiments, but should be defined only in accordance with the following claims and their equivalents.

What is claimed is:

1. A method comprising:
collecting, by a processor, data from a plurality of communication channels related to a plurality of touchpoints;
determining, by the processor, a plurality of journeys from the plurality of touchpoints, where at least one of the plurality of journeys is classified as a negative journey;
determining, by the processor, a start of the negative journey by a user; and
interacting, by the processor, with an endpoint device of the user before a next touchpoint for the negative journey is reached by the user.

2. The method of claim 1, wherein the interacting comprises a remedial action to be initiated by a provider.

3. The method of claim 1, wherein the provider comprises a service provider.

4. The method of claim 1, wherein the remedial action comprises a telephone call initiated by the service provider directed to the endpoint device of the user.

5. The method of claim 1, wherein the remedial action comprises a message sent by the service provider directed to the endpoint device of the user.

6. The method of claim 1, wherein the processor is employed by a network service provider.

7. The method of claim 6, wherein the network service provider provides at least one of: a communication service, a data service, or a multimedia service.

8. The method of claim 1, further comprising:
determining, by the processor, the user has reached the next touchpoint and the user will continue on the negative journey; and
adjusting, by the processor, an interaction with the user during the next touchpoint.

9. The method of claim 8, wherein the determining the user will continue on the negative journey is based on at least one propensity score.

10. The method of claim 9, wherein the at least one propensity score comprises at least one of: a likely to contact propensity score, a likely to repeat contact propensity score, a likely to fail propensity score and a likely to adopt propensity score.

11. The method of claim 1, wherein the determining the start of the negative journey by the user is based on at least one propensity score.

12. A tangible computer-readable storage device storing a plurality of instructions which, when executed by a processor, cause the processor to perform operations, the operations comprising:
collecting data from a plurality of communication channels related to a plurality of touchpoints;
determining a plurality of journeys from the plurality of touchpoints, where at least one of the plurality of journeys is classified as a negative journey;
determining a start of the negative journey by a user; and
interacting with an endpoint device of the user before a next touchpoint for the negative journey is reached by the user.

13. The tangible computer-readable storage device of claim 12, wherein the interacting comprises a remedial action to be initiated by a provider.

14. The tangible computer-readable storage device of claim 12, wherein the provider comprises a service provider.

15. The tangible computer-readable storage device of claim 12, wherein the remedial action comprises a telephone call initiated by the service provider directed to the endpoint device of the user.

16. The tangible computer-readable storage device of claim 12, wherein the remedial action comprises a message sent by the service provider directed to the endpoint device of the user.

17. The tangible computer-readable storage device of claim 12, wherein the processor is employed by a network service provider.

18. The tangible computer-readable storage device of claim 12, the operations further comprising:
determining the user has reached the next touchpoint and the user will continue on the negative journey; and
adjusting an interaction with the user during the next touchpoint.

19. An apparatus comprising:
a processor; and
a computer-readable storage device storing a plurality of instructions which, when executed by the processor, cause the processor to perform operations, the operations comprising:
collecting data from a plurality of communication channels related to a plurality of touchpoints;
determining a plurality of journeys from the plurality of touchpoints, where at least one of the plurality of journeys is classified as a negative journey;
determining a start of the negative journey by a user; and
interacting with an endpoint device of the user before a next touchpoint for the negative journey is reached by the user.

20. The apparatus of claim 19, wherein the interacting comprises a remedial action to be initiated by a provider.
